(19) United States
(12) Patent Application Publication
(10) Pub. No.: US 2014/0153964 A1
(43) Pub. Date: Jun. 5, 2014

(54) IMAGE FORMING APPARATUS AND METHOD FOR REMOVING JAM USING THE SAME

(71) Applicant: SAMSUNG ELECTRONICS CO., LTD., Suwon (KR)

(72) Inventors: Jeong-yeong PARK, Hwaseong (KR); Chun-sub Ryu, Yongin (KR)

(73) Assignee: SAMSUNG ELECTRONICS CO., LTD., Suwon (KR)

(21) Appl. No.: 13/953,397

(22) Filed: Jul. 29, 2013

(30) Foreign Application Priority Data
Dec. 4, 2012 (KR) 10-2012-0139826

(51) Int. Cl. G03G 15/00; G03G 21/00

(52) U.S. Cl. CPC G03G 15/70
USPC 399/110; 399/124

(57) ABSTRACT

An image forming apparatus capable of removing a jam and a method of removing a jam using the image forming apparatus are provided. The apparatus is capable of removing a jam that occurred at the inside of an apparatus body without separating a tray from a tray guide unit and without increasing the size of the apparatus body by including a tray guide unit having a two-stepped rail structure.

### CROSS-REFERENCE TO RELATED APPLICATIONS

This application is related to, and claims priority to the benefit of Korean Patent Application No. 10-2012-0139826, filed on Dec. 4, 2012, in the Korean Intellectual Property Office, the disclosure of which is incorporated herein in its entirety by reference.

### BACKGROUND

1. Field

Exemplary embodiments of the present invention relate to an image forming apparatus and a method of removing a jam using the same, and more particularly, to an image forming apparatus capable of removing a jam that may be generated in a process of forming an image, and a method of removing a jam using the same.

2. Description of the Related Art

An image forming apparatus radiates modulated light on a photoconductor in response to image information so as to form an electrostatic latent image on the surface of the photoconductor, and supplies toner to the electrostatic latent image so as to form a visible toner image on the surface of the photoconductor. After transferring the visible image to a recording medium, printing is performed by a fixing scheme using heat and pressure.

In the process of performing printing using the image forming apparatus, the recording medium may be stuck in the apparatus, that is, a jam may occur, due to various reasons such as the state of the recording medium, wear of the internal components of the image forming apparatus, etc. When such a jam occurs, the stuck recording medium needs to be removed.

### SUMMARY

Additional aspects and/or advantages will be set forth in part in the description which follows and, in part, will be apparent from the description, or may be learned by practice of the invention.

According to an aspect of the present invention, an image forming apparatus is provided capable of easily removing a jam without separating a tray from a body of the image forming apparatus or increasing a size of the body of the apparatus.

According to an aspect of the present general invention, a method of removing a jam using the image forming apparatus is provided.

According to an aspect of the present invention an image forming apparatus is provided including an apparatus body, a tray including a developing unit mounted thereon, the tray being drawn in and out through an opening provided in the apparatus body and being movable to a received position where the whole tray is received at an inside of the apparatus body, a first exposure position where part of the tray is exposed to an outside of the apparatus body, and a second exposure position where the whole tray is exposed to the outside of the apparatus body, a transfer unit installed in the apparatus body, the transfer unit comprising a paper transfer belt (PTB) for directly transferring a visible image formed on the developing unit to a recording medium, and a tray guide unit for guiding drawing in and out of the tray with respect to the apparatus body, the tray guide unit including a 1-stage rail sliding-coupled with the tray and a 2-stage rail sliding-coupled with the 1-stage rail.

One of the 1-stage rail and the 2-stage rail may guide movement of the tray in a space between the received position and the first exposure position, and the other of the 1-stage rail and the 2-stage rail may guide movement of the tray in a space between the first exposure position and the second exposure position.

The tray may include a guide rail sliding-coupled with the 1-stage rail.

Part of the 1-stage rail may be exposed to the outside of the apparatus body when the tray is positioned in the second exposure position.

A distance between a front end of the tray and the apparatus body may be between about 5 cm and about 15 cm when the tray is positioned at the second exposure position.

The tray may include a first stopper to not be separated from the 1-stage rail, and the 1-stage rail includes a second stopper to not be separated from the 2-stage rail.

A lubrication member for assisting a sliding movement of the 1-stage rail on the 2-stage rail may be disposed between the 1-stage rail and the 2-stage rail.

The 1-stage rail and the 2-stage rail may be singular or plural, respectively.

A plurality of 1-stage rails and 2-stage rails may be arranged in a direction crossing the in/out direction of the tray.

The image forming apparatus may include a fixing guide fixed on the apparatus body, the fixing guide guiding the 2-stage rail such that the developing unit approaches or is separated from the PTB.

One of the 2-stage rail and the fixing guide may include a projected boss, and the other of the 2-stage rail and the fixing guide includes a long hole for guiding the boss by receiving the boss.

The image forming apparatus may include a door member for opening and closing the opening, and a connection member for connecting the door member with the 2-stage rail.

The 2-stage rail may be moved in a direction in which the 2-stage rail is separated from the PTB when the door member is opened.

The developing unit may be detachable from the tray in a direction parallel to the direction of gravity.

According to an aspect of the present invention, a method of removing a jam of an image forming apparatus is provided including preparing an apparatus body having an opening for drawing in and out of a tray, the apparatus body comprising a developing unit mounted on the tray and a transfer unit directly transferring a visible image formed on the developing unit to a recording medium, drawing out the tray along a tray guide unit such that part of the tray is exposed to an outside of the apparatus body, drawing out the tray along the tray guide unit such that the whole tray is exposed to the outside of the apparatus body, and removing the jam through the opening.

The tray guide unit may include a 1-stage rail sliding-coupled with the tray and a 2-stage rail sliding-coupled with the 1-stage rail.

One of the 1-stage rail and the 2-stage rail may guide movement of the tray when drawing out the tray along the tray guide unit such that part of the tray is exposed to the outside of the apparatus body.

The other of the 1-stage rail and the 2-stage rail may guide movement of the tray when drawing out the tray along the tray guide unit such that the whole tray is exposed to the outside of the apparatus body.

The tray may be drawn out such that a distance between the tray and the apparatus body is between about 5 cm and about 15 cm when drawing out the tray along the tray guide unit such that the whole tray is exposed to the outside of the apparatus body.

The developing unit mounted on the tray may be detached and exchanged in a direction parallel to the direction of gravity when drawing out the tray along the tray guide unit such that part of the tray is exposed to the outside of the apparatus body or when drawing out the tray along the tray guide unit such that the whole tray is exposed to the outside of the apparatus body.

### BRIEF DESCRIPTION OF THE DRAWINGS

The above and/or other features and advantages of the present general inventive concept will become more apparent by describing in detail exemplary embodiments thereof with reference to the attached drawings in which:

FIG. 1 illustrates an image forming apparatus according to an exemplary embodiment of the present invention;

FIG. 2 illustrates an example of an occurrence of a jam in a image forming apparatus;

FIG. 3 illustrates an exemplary tray guide unit of a image forming apparatus;

FIGS. 4A to 4C illustrate an exemplary operation state of a tray guide unit;

FIGS. 5A to 5C illustrate an exemplary operation state of a tray guide unit;

FIG. 6 illustrates an exemplary connection part of a tray guide unit;

FIG. 7 is a cross-sectional view illustrating an exemplary coupling state between a tray guide unit and a tray;

FIG. 8 illustrates a tray guide unit of an image forming apparatus according to an exemplary embodiment of the present invention; and

FIGS. 9A and 9B illustrate an exemplary tray guide unit of an image forming apparatus according to an exemplary embodiment of the present invention.

### DETAILED DESCRIPTION

Exemplary embodiments of the present invention are described with reference to the accompanying drawings, in which exemplary embodiments of the present invention are illustrated.

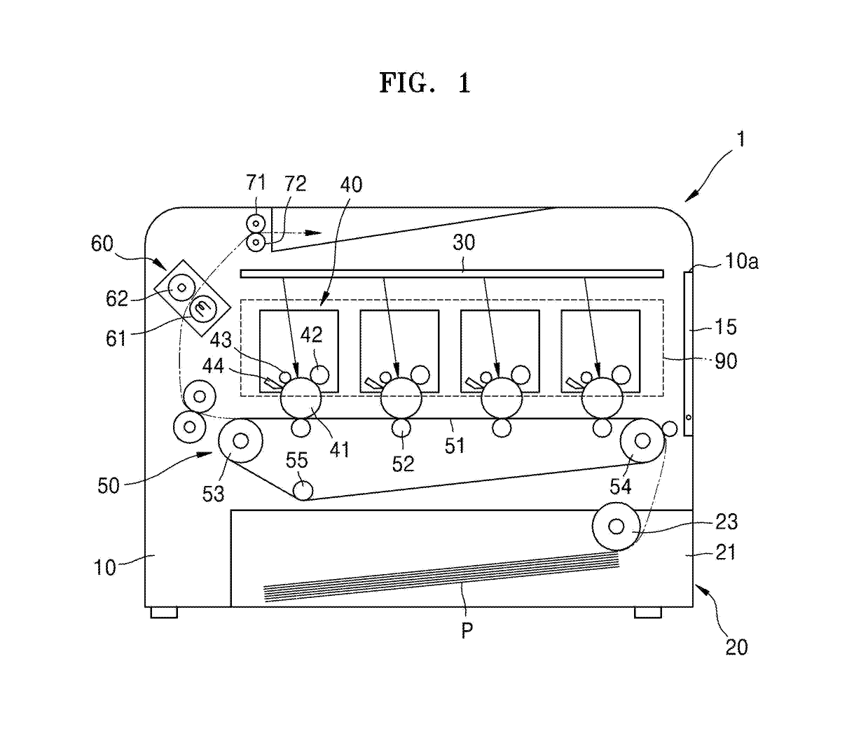

FIG. 1 illustrates an image forming apparatus 1 according to an exemplary embodiment of the present invention.

Referring to FIG. 1, the image forming apparatus 1 according to an exemplary embodiment of the present invention may include an apparatus body 10, a paper feeding unit 20, a laser scanning unit 30, a developing unit 40, a transfer unit 50, a fusing unit 60, and a discharging unit 71, 72.

The apparatus body 10 forms an external appearance of the image forming apparatus 1. The apparatus body 10 includes the paper feeding unit 20, the laser scanning unit 30, the transfer unit 50, the fusing unit 60, and the discharging unit 71, 72. An opening 10a may be formed in the apparatus body 10, and a door member 15 for opening or closing the opening 10a may be installed.

The paper feeding unit 20 supplies a recording medium P to the developing unit 40. The paper feeding unit 20 includes a cassette 21 that may be detachably mounted on the apparatus body 10. The recording medium P is loaded on the cassette 21, and when printing is performed, sheets of recording media P loaded on the cassette 21 may be picked up one-by-one by a pickup roller 23. A recording medium P picked up by the pickup roller 23 may be moved in the direction of the transfer unit 50 and the developing unit 40.

The laser scanning unit 30 radiates light corresponding to image information inputted from the outside to a photoconductor 41 so as to form an electrostatic latent image on a surface of the photoconductor 41. In a case of a color image forming apparatus as the image forming apparatus 1 as illustrated in FIG. 1, the laser scanning unit 30 may be configured to radiate light corresponding to yellow Y, magenta M, cyan C, and black K to the photoconductor 41.

The developing unit 40 may include four (4) developing units 40 containing yellow Y, magenta M, cyan C, and black K developers, respectively. Each developing unit 40 may include a photoconductor 41, a charge roller 43 for charging the photoconductor 41, a developing roller 42 for forming a visible image by supplying developers to an electrostatic latent image formed on the photoconductor 41, and a cleaning member 44 for removing developers remaining on a photoconductor after transfer. The colors of the toners contained in the developing units 40 may be different, but each developing unit 40 may have the same configuration. Though not illustrated in the drawings, the developing unit 40 may include a plurality of electrical contacts (not shown) for applying a voltage to each of the photoconductor 41, the charge roller 43, the developing roller 42, and the cleaning member 44. Though not illustrated in the drawings, the developing unit 40 may include a plurality of electrical contacts (not shown) for respectively applying a voltage to the photoconductor 41, the charge roller 43, the developing roller 42, and the cleaning member 44.

When the developers included inside the developing unit are fully consumed, the developing unit 40 may be substituted by a new developing unit 40. The developing unit 40 may be mounted on a tray 90 installed in a manner that the tray 90 may enter and exit the apparatus body 10. The developing unit 40 may be mounted in a direction parallel to the direction of gravity. A plurality of developing units 40 may be inserted at one time by inserting the developing units 40 into the apparatus body 10 through the tray 90. The tray 90 may be drawn out from the apparatus body 10 after opening the door member 15 installed in an in/out path of the tray 90.

The transfer unit 50 transfers the visible image formed on the surface of the photoconductor 41 to the recording medium P. The transfer unit 50 may include a conveyance belt 51 for conveying the recording medium P and 4 transfer rollers 52 for transferring a visible image formed on the surface of each photoconductor 41 to the recording medium P conveyed to the conveyance belt 51. The conveyance belt 51 may be rotated in a state in which a predetermined tension exists using a driving roller 53, a tension roller 55, and a passivity roller 54. The conveyance belt 51 may be a paper transfer belt (PTB) for directly transferring the visible image formed on the photoconductor 41 to the recording medium P. A voltage having a polarity opposite to that of the developer attached on each photoconductor 41 is applied to the transfer roller 52. A visible image formed on the photoconductor 41 may be transferred to the recording medium P moved by the conveyance belt 51.

The fusing unit 60 includes a heating part 61 and a compression roller 62. The fusing unit 60 applies heat and pressure to the recording medium P, which passes and moves between the heating part 61 and the pressure roller 62, and fixes the non-fixed image of the recording medium P on the recording medium P.

The discharging unit 71, 72 discharges the recording medium P, which has passed the fusing unit 60, to the outside of the image forming apparatus 1. The discharging unit 71, 72 may include a discharge roller 71 and a discharge backup roller 72 installed against the discharge roller 71.

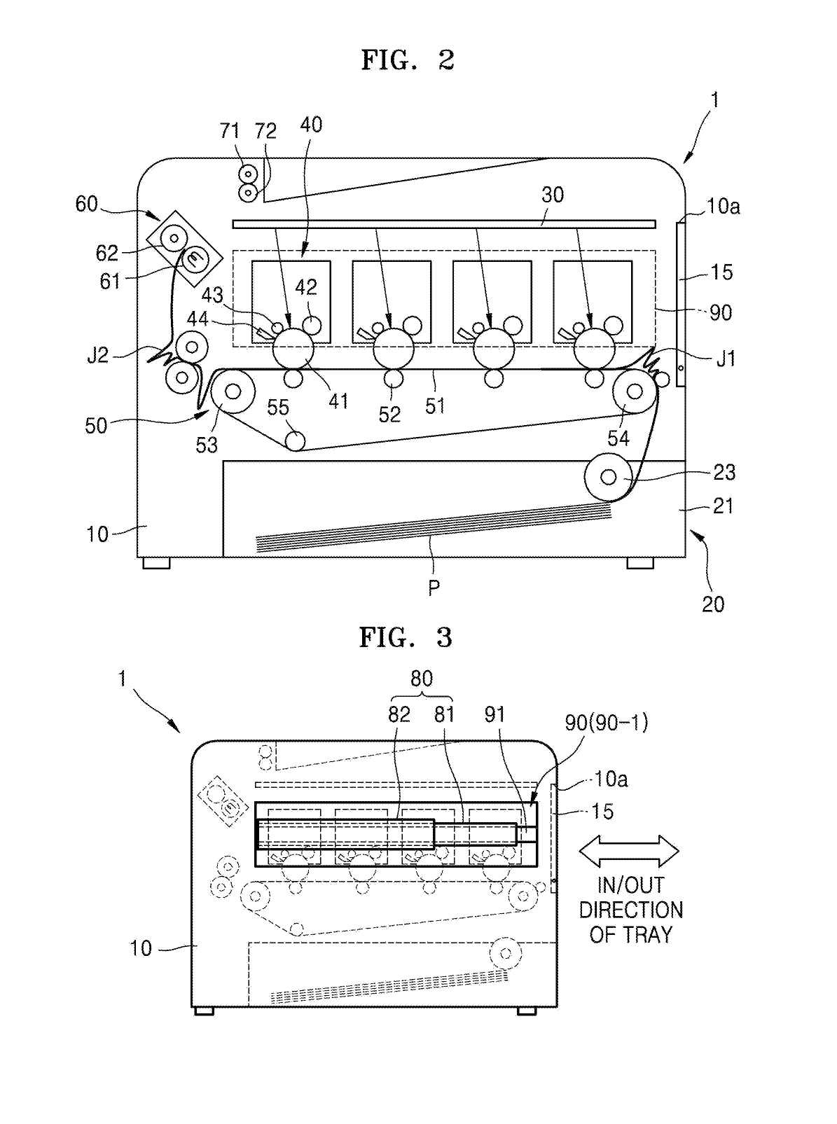

FIG. 2 illustrates an example of an occurrence of a jam in an image forming apparatus, for example, image forming apparatus 1 of FIG. 1, and FIG. 3 illustrates a tray guide unit of an image forming apparatus, for example, image forming apparatus 1 of FIG. 1.

Referring to FIG. 2, in the image forming apparatus 1, a recording medium P may be stuck, that is, a jam may occur, due to a state of the recording medium P, wear of the parts installed in the apparatus body 10, etc. in a printing process where an image is formed on the recording medium P. For example, when a direct transfer method, in which a visible image formed on the photoconductor 41 is directly transferred to the recording medium P, is adopted as the transfer method of the image forming apparatus 1, a recording medium J1 may be stuck in the process where the recording medium J1 enters or passes the area between the photoconductor 41 and the conveyance belt 51. A recording medium J2 may be stuck in the process where the recording medium J2 passes the conveyance belt 51 and enters or passes the fusing unit 60. In order to resolve the jam, the door member 15 may be opened so as to take out the tray 90, and the stuck recording media J1 and J2 removed.

Referring to FIG. 3, in the image forming apparatus 1 according to an exemplary embodiment of the present invention, a tray guide unit 80 may have a two-stepped rail structure in which a drawing length of the tray 90 may be extended. As such, the jam may be removed in a state in which a separate space for removing the jam is not formed in the tray 90 while not separating the tray 90 from the apparatus body 10. If the tray 90 is separated from the apparatus body 10, the jam may be removed, but the tray 90 or a member guiding the tray may be damaged in the process of separating or remounting the tray 90. If a separate space is formed in the tray 90, the size of the apparatus body 10 may be increased.

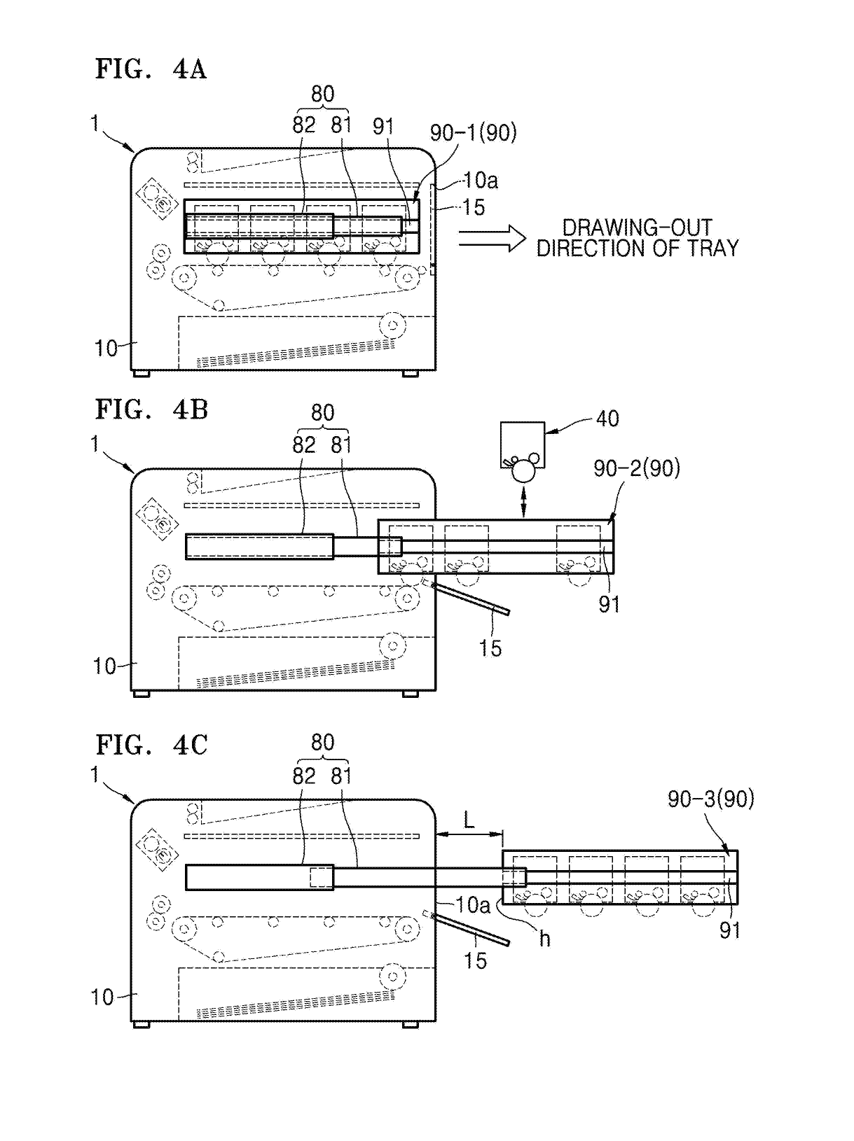

The tray guide unit 80 according to an exemplary embodiment of the present invention may have a two stepped rail structure so that the drawing length of the tray 90 may be extended without increasing the size of the apparatus body 10. The tray guide unit 80 may be installed in the apparatus body 10 in parallel to an in/out direction of the tray 90 so that the drawing in/out of the tray 90 with respect to the apparatus body 10 may be guided. The tray guide unit 80 guides the movement to a received position where the whole tray 90 is received in the apparatus body 10 (90-1), a first exposure position where part of the tray 90 is exposed to the outside of the apparatus body 10 (90-2, see, for example, FIG. 4B), and a second exposure position where the whole tray 90 is exposed to the outside of the apparatus body 10 (90-3, see, for example, FIG. 4C). The tray guide unit 80 may include a 1-stage rail 81 and a 2-stage rail 82. The 1-stage rail 81 and the 2-stage rail 82 may be installed to be against one side or both sides of the tray 90.

The 1-stage rail 81 may be sliding-coupled with a guide rail 91 formed on the tray 90, and directly guide movement of the tray 90. The 2-stage rail 82 may be sliding-coupled with the 1-stage rail 81, and indirectly guide movement of the tray 90. The 1-stage rail 81 and the 2-stage rail 82 may be installed in parallel to the in/out direction of the tray 90 that enters and exits in a one-dimensional path.

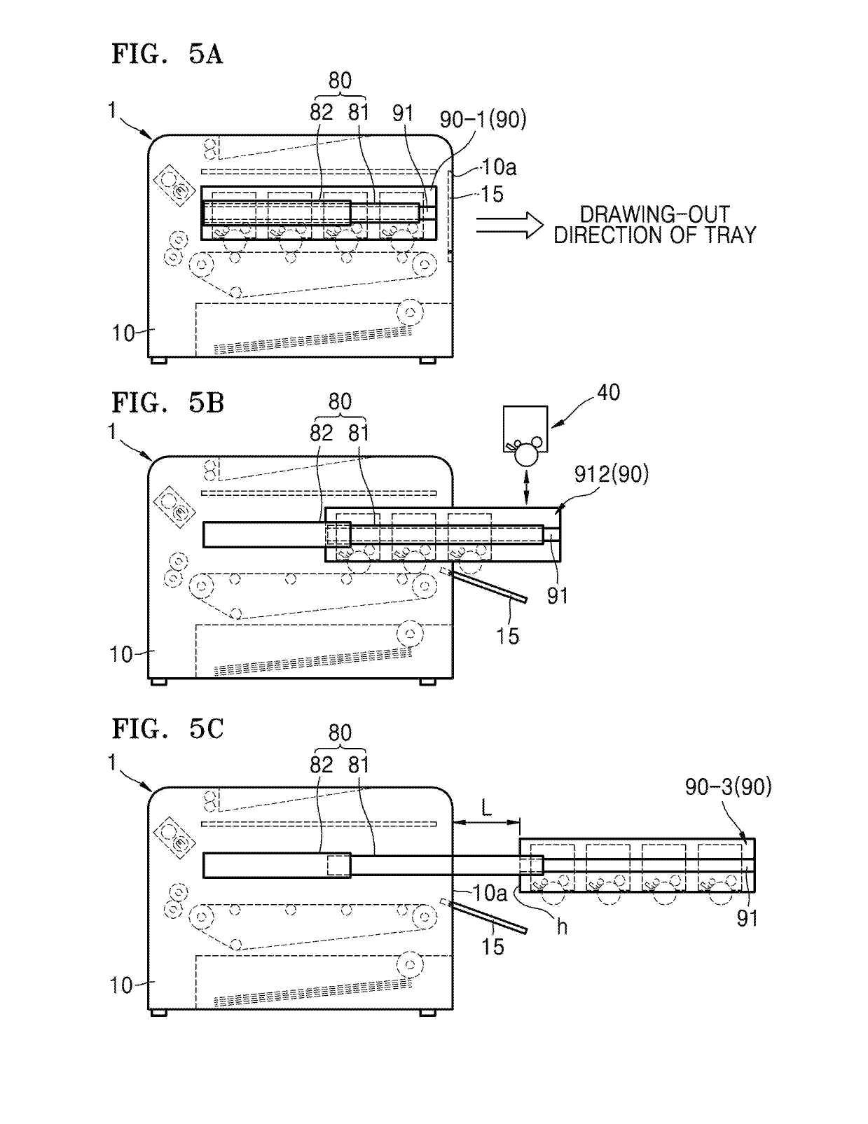

FIGS. 4A to 4C illustrate an exemplary operation state of a tray guide unit, e.g., the tray guide unit 80 of FIG. 3. FIGS. 5A to 5C illustrate another exemplary operation state of a tray guide unit, e.g., the tray guide unit 80 of FIG. 3.

FIGS. 4A and 5A illustrate an exemplary state in which the tray 90 is positioned in the received position 90-1. Referring to FIGS. 4A and 5A, the entire, or most of the, 1-stage rail 81 is sliding-coupled with the guide rail 91 so as to be overlapped with the guide rail 91, and the entire, or most of the, 2-stage rail 82 is sliding-coupled with the 1-stage rail 81 so as to be overlapped with the 1-stage rail 81. The jam (J1, see, for example, FIG. 2) that occurs near the door member 15 may be easily removed through the opening 10a by opening the door member 15 in a state in which the tray 90 is positioned in the received position 90-1.

FIGS. 4B and 5B illustrate an exemplary state of the first exposure positions 90-2 and 912. If a force is applied to the tray 90 in a drawing-out direction, the tray 90 may move relatively to the 1-stage rail 81 so as to be positioned in the first exposure position 90-2 where part of the tray 90 is exposed to the outside of the apparatus body 10 as illustrated in FIG. 4B. The 1-stage rail 81 may be supported by the 2-stage rail 82 so as not to be moved relative to the 2-stage rail 82. However, the operation state of the tray 90 and the 1-stage rail 81 are not limited thereto, and the operation state may be changed according to the force applied between the tray 90 and the 1-stage rail 81 and the force between the 1-stage rail 81 and the 2-stage rail 82. For example, when the friction force applied between the tray 90 and the 1-stage rail 81 is greater than the force between the 1-stage rail 81 and the 2-stage rail 82, as illustrated in FIG. 5B, the 1-stage 81 may move relatively to the 2-stage rail 82 in the state in which the 1-stage rail 81 is supported by the tray 80 so as not to be moved relative to the tray 80, so that the tray 90 may be positioned in the first exposure position 912. In a state in which the tray 90 is positioned in the first exposure positions 90-2 and 912, i.e., the tray 90 may be first drawn out, the developing unit 40 mounted on the tray 90 may be changed in a direction parallel to the direction of gravity. The first exposure positions 90-2 and 912 of the tray 90 may be adjusted by changing the length of the 1-stage rail 81, the 2-stage rail 82, or the guide rail 91, and the force applied between them, etc.

FIGS. 4C and 5C illustrate an exemplary state in which a tray 90 is positioned in a second exposure position 90-3. If the force is applied to the tray 90 positioned in the first exposure positions 90-2 and 912 in a drawing-out direction, the tray 90 is positioned in the second exposure position 90-3. The tray 90 is not separated from the 1-stage rail 81, but maintains being coupled with the 1-stage rail 81. Though not illustrated in the drawings, the developing unit 40 mounted on the tray 90 may be changed in a direction parallel to the direction of gravity. The whole tray 90 may be exposed to the outside of the apparatus body 10 as the 1-stage rail 81 is moved relative to the 2-stage rail as illustrated in FIG. 4C, or the tray is moved relative to the 1-stage rail 81 as illustrated in FIG. 5C. The inside of the apparatus body 10 may be exposed through the opening as the whole tray 90 is exposed to the outside of the apparatus body 10. The user may easily remove the jam (J2, see, for example, FIG. 2) that occurred near the fusing unit 60, which is located relatively far away from the door member 15, as well as the jam (J1, see, for example, FIG. 2) that occurred in the in/out path of the tray 90 through the opening 10a. The image forming apparatus 1 according to an exemplary embodiment of the present invention is effective if a jam is removed in a direct transfer scheme. The distance “L” between a front end “h” of the tray 90 and the apparatus body 10 may be between about 5 cm and about 15 cm. If the distance “L” is less than 5 cm, it may be difficult for the user to remove the jams J1 and J2 through the opening 10a, and if the distance “L” exceeds 15 cm, the tray guide unit 80 may be damaged by the load of the tray 90.

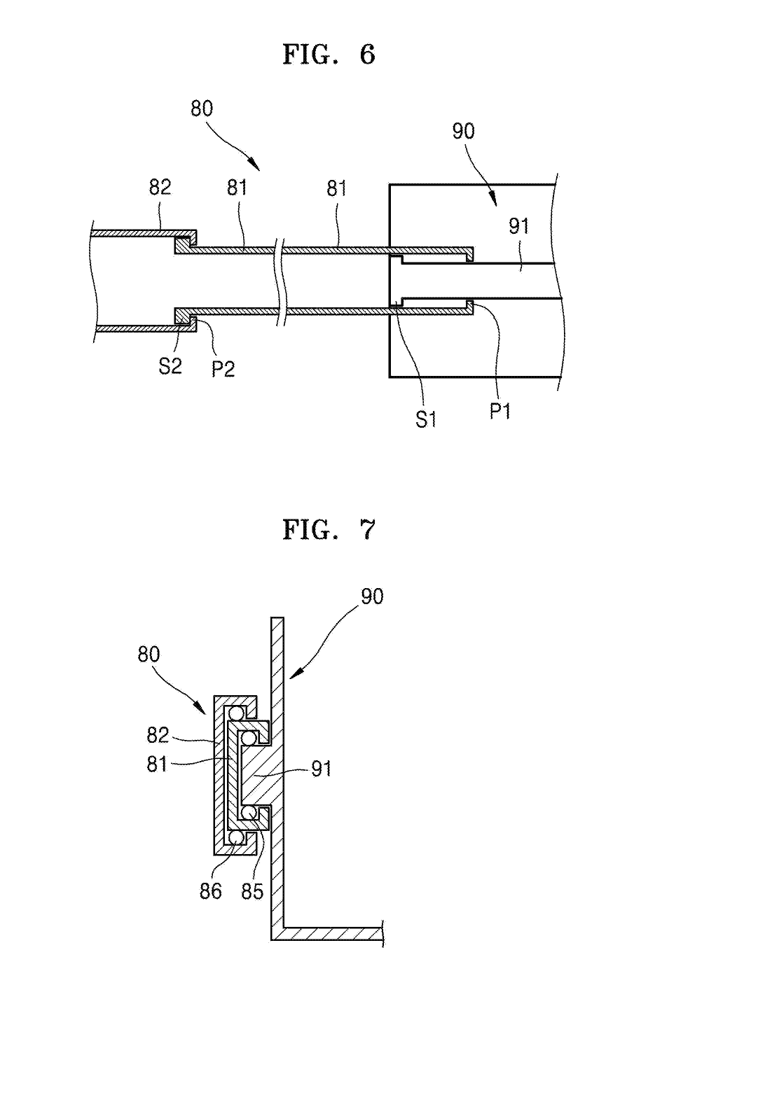

FIG. 6 illustrates an exemplary connection part of the tray guide unit 80 of FIG. 3. Referring to FIG. 6, the tray 90 may be moved in a range in which the tray 90 is not separated from the 1-stage rail 81. The tray 90 may include a first stopper 51 formed on the guide rail 91. The movement of the tray 90 by the 1-stage rail 81 may be restricted as the first stopper 51 is caught on a first projection part P1 projected to the inside of the 1-stage rail 81. The 1-stage rail 81 may move within a range in which the 1-stage rail 81 is not separated from the 2-stage rail 82. The 1-stage rail 81 may include a second stopper S2. The 1-stage rail 81 may be prevented from being separated from the 2-stage rail 82 as the second stopper S2 is caught on a second projection part P2 projected to the inside of the 2-stage rail 82. The exemplary embodiment illustrates an example in which the tray 90 and the 1-stage rail 82 are prevented from separating through the hanging structure of the projection parts P1 and P2 and the first and second stoppers S1 and S2. However, the present invention is not limited to this example, and a modified arrangement and form for preventing the tray 90 and the 1-stage rail 81 from separating may be applied.

FIG. 7 illustrates an exemplary coupling state between the tray guide unit 80 and the tray 90 of FIG. 3. Referring to FIG. 7, the tray 90 may be sliding-coupled with the 1-stage rail 81 through the guide rail 91. The 1-stage rail 81 may be sliding-coupled with the 2-stage rail 82.

A first lubrication member 85 for assisting the sliding movement of the guide rail 91 on the 1-stage rail 81 may be installed between the guide rail 91 and the 1-stage rail 81. For example, a ball bearing for structurally assisting the sliding movement may be used as the first lubrication member 85. However, the first lubrication member 85 is not limited to this example, and grease for assisting the sliding movement by the attributes of the material, etc. may also be used.

A second lubrication member 86 for assisting the sliding movement of the 1-stage rail 81 on the 2-stage rail 82 may be installed between the 1-stage rail 81 and the 2-stage rail 82. As an example of the second lubrication member 86, a ball bearing for structurally assisting the sliding movement may be used. However, the second lubrication member 86 is not limited to this example, and grease for assisting the sliding movement by the attributes of the material, etc. may also be used.

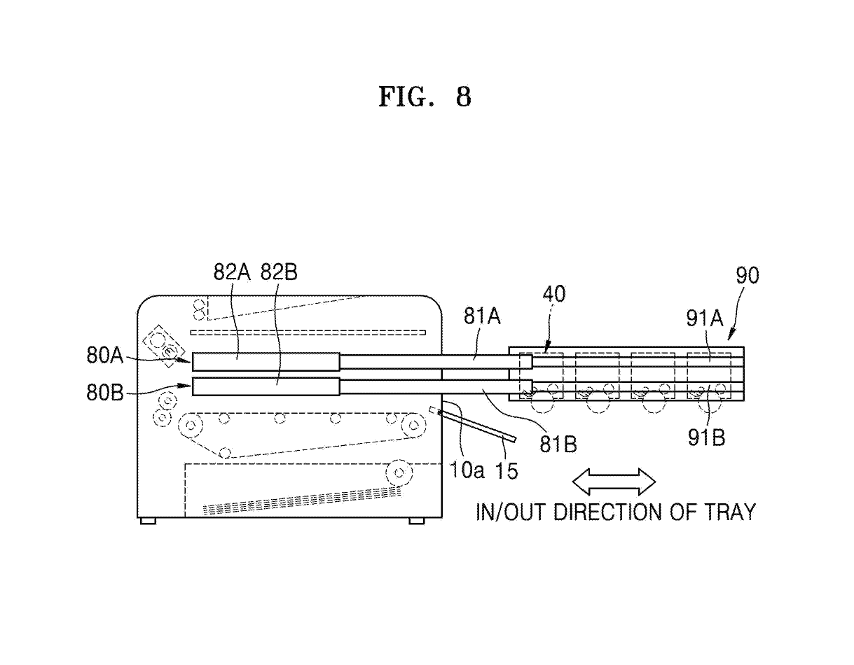

FIG. 8 illustrates a tray guide unit of an image forming apparatus according to an exemplary embodiment of the present invention.

Referring to FIG. 8, a plurality of tray guide units 80A and 80B may be included. That is, a plurality of 1-stage rails 81 and a plurality of 2-stage rails 82 may be included. The plurality of 1-stage rails 81A and 81B and 2-stage rails 82A and 82B may be arranged in a direction crossing an in/out direction of the tray 90. For example, the first rail 81A and the second rail 82A may be arranged in a direction perpendicular to the in/out direction of the tray 90. The 1-stage rail 81A and the 2-stage rail 81B may stably support the load by the tray 90 and the developing unit 40 mounted on the tray 90. As such, the tray guide units 80A and 80B may be prevented from being bent or broken by the load of the tray 90 and the developing unit 40. FIG. 8 illustrates a case in which there are two 1-stage rails 81A and 81B and two 2-stage rails 82A and 82B. However, the present invention is not limited to this example, and the respective number of 1-stage rails and 2-stage rails may be three or more.

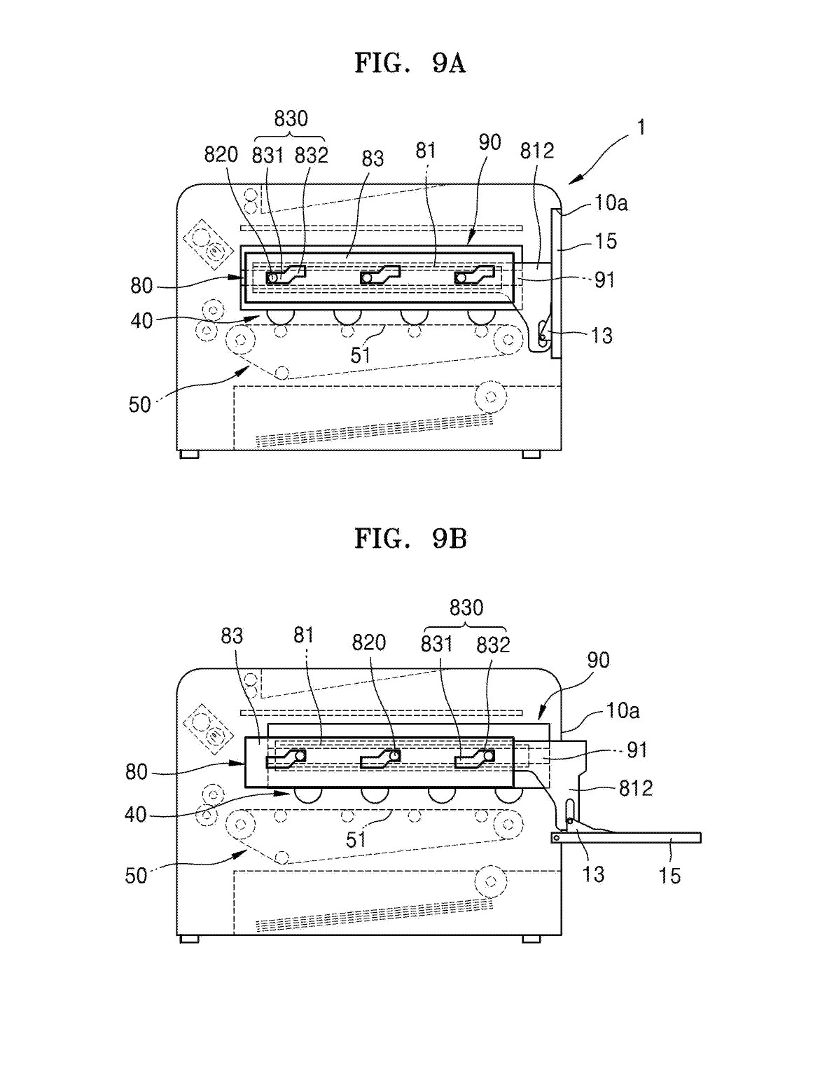

FIGS. 9A and 9B schematically illustrate a tray guide unit of an image forming apparatus according to an exemplary embodiment of the present invention. Referring to FIG. 9A, the tray guide unit 80 may include a fixing guide 83 fixed at the apparatus body 10. A repeated description of same configuration of an exemplary embodiment disclosed in FIG. 3 is omitted.

The fixing guide 83 may guide a 2-stage rail 812 so that the developing unit 40 may approach or be separated from the conveyance belt 51 of the transfer unit 50. To this end, one of the fixing guide 83 and the 2-stage rail 812 may include a projected boss, and the other may include a long hole 830 for guiding the boss 820. For example, the 2-stage rail 812 includes a boss projected toward the fixing guide 83, and the fixing guide 83 includes a long hole 830, into which the boss 820 may be inserted. When the external force is applied to the 2-stage rail 812, the boss 820 of the 2-stage rail 812 may be moved according to the pattern of the long hole 830 of the fixing guide 83. The long hole 830 may include a contact region 831 in which the developing unit 40 mounted on the tray 90 contacts the conveyance belt 51 of the transfer unit 50, and a separation region 832 in which the developing unit 40 is separated from the conveyance belt 51 of the transfer unit 50.

A connection member 13 may be disposed between the 2-stage rail 812 and the door member 15 to connect the 2-stage rail 812 with the door member 15. The 2-stage rail 812 may have a form extended in a direction of the door member 15 so as to be connected to one end of the connection member 13. As illustrated in FIG. 9B, when the door member 15 is opened, the connection member 13 may be moved in a direction in which the 2-stage rail 812 is separated from the transfer unit 50 along the pattern of the long hole 830 by transmitting external force applied to the door member 15 to the 2-stage rail 812. The 1-stage-rail 81 sliding-coupled to the 2-stage rail 812 and the developing unit 40 of the tray 90 sliding-coupled to the 1-stage rail 81 may be moved in a direction in which the 1-stage rail 81 is separated from the transfer unit 50 through the movement of the 2-stage rail 812.

The present invention has been described with reference to exemplary embodiments illustrated in the drawings, but they are merely examples. For example, the described embodiments describe an image forming apparatus for forming a color image using toners of cyan C, magenta M, yellow Y and black K colors, but the present invention is not limited thereto. The image forming apparatus according to the present invention may be applied to an image forming apparatus for forming an image on a recording medium using various schemes such as an image forming apparatus 1 that uses a single color toner. A description has been made of a two-stepped rail structure for the extension of the drawing-out length of the tray 90, but the present invention is not limited thereto, and a three or more-stepped rail structure may be used.

According to an image forming apparatus and a method of removing a jam using the same of the present invention, a jam that occurs at an inside of an apparatus body may be removed without separating a tray from a tray guide unit and without increasing the size of the apparatus body by including a tray guide unit having a two-stepped rail structure.

While the present invention has been particularly shown and described with reference to exemplary embodiments thereof, it will be understood by those of ordinary skill in the art that various changes in form and details may be made therein without departing from the spirit and scope of the present general inventive concept as defined by the following claims.

1. An image forming apparatus comprising:
an apparatus body;
a tray including a developing unit mounted thereon, the tray capable of being drawn in and out through an opening provided in the apparatus body and being movable to a received position where the whole tray is received at an inside of the apparatus body, a first exposure position where a part of the tray is exposed to an outside of the apparatus body, and a second exposure position where the whole tray is exposed to the outside of the apparatus body;
a transfer unit installed in the apparatus body, the transfer unit comprising a paper transfer belt (PTB) for directly transferring a visible image formed on the developing unit to a recording medium; and
a tray guide unit for guiding the drawing in and out of the tray with respect to the apparatus body, the tray guide unit including a 1-stage rail sliding-coupled with the tray and a 2-stage rail sliding-coupled with the 1-stage rail.

2. The image forming apparatus of claim 1, wherein one of the 1-stage rail and the 2-stage rail guides a movement of the tray in a space between the received position and the first exposure position, and the other of the 1-stage rail and the 2-stage rail guides a movement of the tray in a space between the first exposure position and the second exposure position.

3. The image forming apparatus of claim 1, wherein the tray includes a guide rail sliding-coupled with the 1-stage rail.

4. The image forming apparatus of claim 1, wherein part of the 1-stage rail is exposed to the outside of the apparatus body when the tray is positioned in the second exposure position.

5. The image forming apparatus of claim 1, wherein a distance between a front end of the tray and the apparatus body is between about 5 cm and about 15 cm when the tray is positioned at the second exposure position.

6. The image forming apparatus of claim 1, wherein the tray includes a first stopper to not be separated from the 1-stage rail, and the 1-stage rail includes a second stopper to not be separated from the 2-stage rail.

7. The image forming apparatus of claim 1, wherein a lubrication member for assisting a sliding movement of the 1-stage rail on the 2-stage rail is disposed between the 1-stage rail and the 2-stage rail.

8. The image forming apparatus of claim 1, wherein the 1-stage rail and the 2-stage rail are singular or plural, respectively.

9. The image forming apparatus of claim 8, wherein a plurality of 1-stage rails and 2-stage rails are arranged in a direction crossing the in/out direction of the tray.

10. The image forming apparatus of claim 1, further comprising:
a fixing guide fixed on the apparatus body, the fixing guide guiding the 2-stage rail such that the developing unit approaches or is separated from the PTB.

11. The image forming apparatus of claim 1, wherein one of the 2-stage rail and the fixing guide includes a projected boss, and the other of the 2-stage rail and the fixing guide includes a long hole for guiding the boss by receiving the boss.

12. The image forming apparatus of claim 11, further comprising:
a door member for opening and closing the opening; and
a connection member for connecting the door member with the 2-stage rail.

13. The image forming apparatus of claim 12, wherein the 2-stage rail is moved in a direction in which the 2-stage rail is separated from the PTB when the door member is opened.

14. The image forming apparatus of claim 1, wherein the developing unit is detachable from the tray in a direction parallel to the direction of gravity.

15. A method of removing a jam of an image forming apparatus, the method comprising:
preparing an apparatus body having an opening for drawing in and out of a tray, the apparatus body comprising a developing unit mounted on the tray and a transfer unit capable of directly transferring a visible image formed on the developing unit to a recording medium;
drawing out the tray along a tray guide unit such that a part of the tray is exposed to an outside of the apparatus body;
drawing out the tray along the tray guide unit such that the whole tray is exposed to the outside of the apparatus body; and
removing the jam through the opening.

16. The method of claim 15, wherein the tray guide unit includes a 1-stage rail sliding-coupled with the tray and a 2-stage rail sliding-coupled with the 1-stage rail.

17. The method of claim 16, wherein one of the 1-stage rail and the 2-stage rail guides a movement of the tray when drawing out the tray along the tray guide unit such that a part of the tray is exposed to the outside of the apparatus body.

18. The method of claim 16, wherein the other of the 1-stage rail and the 2-stage rail guides a movement of the tray when drawing out the tray along the tray guide unit such that the whole tray is exposed to the outside of the apparatus body.

19. The method of claim 15, where the tray is drawn out such that a distance between the tray and the apparatus body is between about 5 cm and about 15 cm when drawing out the tray along the tray guide unit such that the whole tray is exposed to the outside of the apparatus body.

20. The method of claim 15, wherein the developing unit mounted on the tray is detached and exchanged in a direction parallel to the direction of gravity when drawing out the tray along the tray guide unit such that part of the tray is exposed to the outside of the apparatus body or when drawing out the tray along the tray guide unit such that the whole tray is exposed to the outside of the apparatus body.

21. (canceled)
